(19) United States
(12) Patent Application Publication
(10) Pub. No.: US 2008/0316587 A1
(43) Pub. Date: Dec. 25, 2008

(54) Solution Flow Prevention in Fluid Focus Lenses

(75) Inventors: Roel R.M. Tijburg, Geldrop (NL); Anna L. Bouwkamp-Wijnoltz, Nuenen (NL); T.R. Grob, Eindhoven (NL); Godefridus J. Verhoeckx, Eindhoven (NL); Pieter Van Der Meer, Breda (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/096,985

(22) PCT Filed: Dec. 5, 2006
(86) PCT No.: PCT/IB06/54607

§ 371 Date: Jun. 11, 2008

Related U.S. Application Data
(60) Provisional application No. 60/749,475, filed on Dec. 12, 2005.

(51) Int. Cl. G02F 1/29; G02B 3/14; G02B 1/06

(52) U.S. Cl. 359/319; 359/666

(57) ABSTRACT

In a fluid focus lens (ffl) a structured hydrophobic layer (415) is applied on a hydrophilic glass substrate (406). The hydrophobic layer (415) and hydrophilic glass substrate (406) cause a water droplet placed on the hydrophilic glass substrate (406) to remain in a defined position (or area). The hydrophobic layer prevents leakage when a core (408) of the ffl is not attached to the substrate (406). The hydrophobic layer (415) also functions as a barrier to keep the water in a droplet shape, which simplifies the assembly of the ffl product.

This application claims the benefit of US Provisional Application (insert reference information on provisional filing in nonprovisional application) (Attorney Docket ______), filed Dec. ______, 2005 and is a continuation-in-part of Application No. PCT/WO/IB2005/051435 (Attorney Docket NL050252), filed May 3, 2005.

The invention relates to a hydrophobic layer of an electro-wetting cell and also relates to an electro-wetting cell, in particular an electro-wetting cell of a fluid focus lens, incorporating the layer and a method of assembling such a cell.

In an electro-wetting cell a voltage is used to modify the wetting ability of a material. Two immiscible fluids in the cell may be in contact at a meniscus, one of the two fluids being electrically insulating and the other, electrically conducting. The shape of the meniscus is variable under the influence of the voltage between two electrodes, one of which is, in one configuration of electro-wetting cell, connected to the electrically conducting fluid and the other to a surface which is separated from the fluids by a fluid contact layer. The voltage causes an electro-wetting effect whereby the shape of the meniscus is altered. Fluid focus lenses are lenses in which light is refracted by a meniscus between two immiscible fluids in an electro-wetting cell.

Such a fluid focus lens is known, for instance, from PCT published patent application WO-03/069380 A1, published Jan. 24, 2003. In that application, a lens structure disclosed is substantially cylindrical, with the fluids contained within a cylindrically-shaped inner space and surrounded first by the fluid contact layer and then by an annular core of a metallic electrode material which is coated with a layer of an electrically insulating material.

Hydrophobic layers within a fluid chamber of an electro-wetting cell are known, for example, from WO-03/069380 A1 in which a fluid contact layer positions a droplet because part of the fluid contact layer is hydrophobic and an adjacent part is hydrophilic.

As an electro-wetting cell has optical properties and includes fluids, it is of primary importance for quality in its assembly process and for adequate operation of the cell, that a complete filling of the cell is achieved and that fluid does not leak out of the cell during assembly. Applicants' prior, copending application no. PCT/WO/IB2005/051435, of which the present invention is a continuation-in-part, the disclosure of which is incorporated by reference in its entirety by reference herein, discloses, inter alia, ways to achieve a complete filling and a prevention of fluid leakage in a completed electro-wetting cell.

To that end, the present invention further provides a fluid focus lens or other device which includes an electro-wetting cell, which device can be assembled easily and is less susceptible to leakage during storage and use.

In one embodiment, a hydrophobic layer is provided on an area of a substrate facing a core or other structure which serves to contain electro-wetting fluid. In one aspect, an area of the substrate facing a fluid chamber of the cell around which the core or other structure is placed, is hydrophilic or is made hydrophilic.

In another embodiment, a structured hydrophobic layer is provided on a relatively hydrophilic substrate. The hydrophobic layer is structured in that it is arranged to confine fluid or discourage the flow of fluid during assembly of the substrate and fluid into an electro-wetting device. The hydrophobic layer may abut a core or other structure containing electro-wetting fluid during assembly or during assembly and in the completed device.

In accordance with one embodiment of the invention, a patterned layer of hydrophobic material is provided on at least a portion of a substrate, the substrate having a surface layer of hydrophilic material exposed or being itself hydrophilic in certain areas where the hydrophobic material is not present.

The invention further provides a method of assembly of a fluid focus lens or other device making use of electro-wetting, in which a core or other structure which serves to contain electro-wetting fluid is placed on a hydrophobic area of a substrate.

In one aspect, a method of the present invention includes a step of providing a hydrophilic surface or surfaces on a substrate having a hydrophobic layer, the hydrophilic surface or surfaces and hydrophobic layer being arranged to hold electro-wetting fluids in areas corresponding to areas to be within a core or other structure in a completed device.

The invention further provides improvement in the quality of an electro-wetting cell by preventing movement and leakage of fluid during assembly of the cell to assure complete filling by liquid of a space within a core of the cell.

In accordance with another embodiment of the invention, there is provided a fluid focus lens comprising a fluid chamber within a core and front and back elements or cover plates, first and second immiscible fluids within the fluid chamber, the fluids separated by a meniscus, a first electrode in the form of the core, at least one layer of a hydrophobic material on the core between the core and the first and second fluids in the fluid chamber, a second electrode in contact with the second fluid, and a hydrophobic layer on the back element between the core and the back element and not exposed or exposed only at an edge, to the interior of the fluid chamber.

In accordance with embodiment(s) of the invention, a hydrophilic area is formed on a part of the substrate, by ultraviolet irradiation, UV/ozone treatment or such other structuring method known to one of skill in the art, after the substrate has been coated with a hydrophobic material.

The hydrophobic material may be any material with a relatively low affinity for water, such as a fluoride, silicone or fluorocarbon. In accordance with an embodiment of the invention, the material of the hydrophobic layer may be, for example, fluor silane or an amorphous fluorocarbon polymer such as Teflon AF1600, a product of Dupont or Cytop, an amorphous fluoropolymer from Asahi Glass Co.

A fluid focus lens embodiment of the invention may be used alone or in combination with other lenses in a camera, an optical recording apparatus or any other optical equipment. The fluid focus lens may be assembled with further lenses, to obtain an optical path as needed, or even to obtain a zoom lens. Alternatively, the fluid focus lens may be used in a display, such as a reflective display, in which case only one of the substrates needs to be optically transparent. The fluid focus lens may also be used as a sensor. A fluid focus lens may be also be referred to in this application as a variable focus lens, the terms being used here interchangeably.

These and other aspects of a patterned substrate, structured hydrophobic layer, fluid focus lens or other electro-wetting device and the method of present invention will be apparent from and further elucidated with reference to the description hereinafter and the Figures, in which:

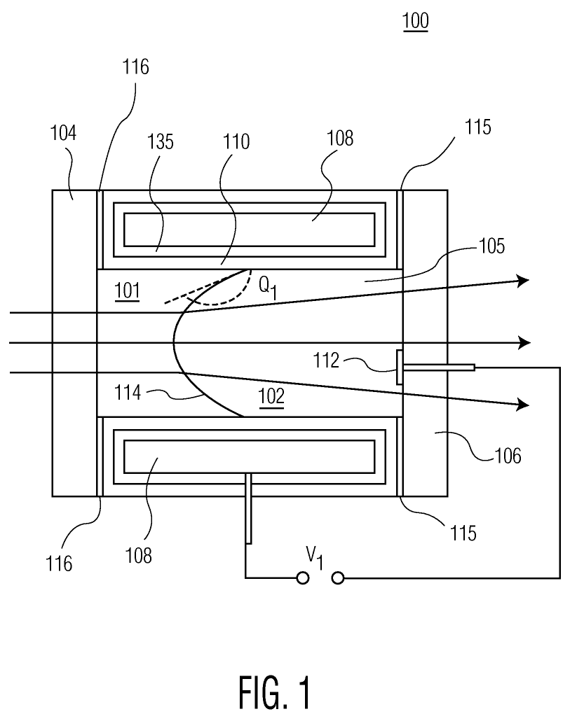

FIG. 1 shows a diagrammatical cross-sectional view of one embodiment of a fluid focus lens of the invention;

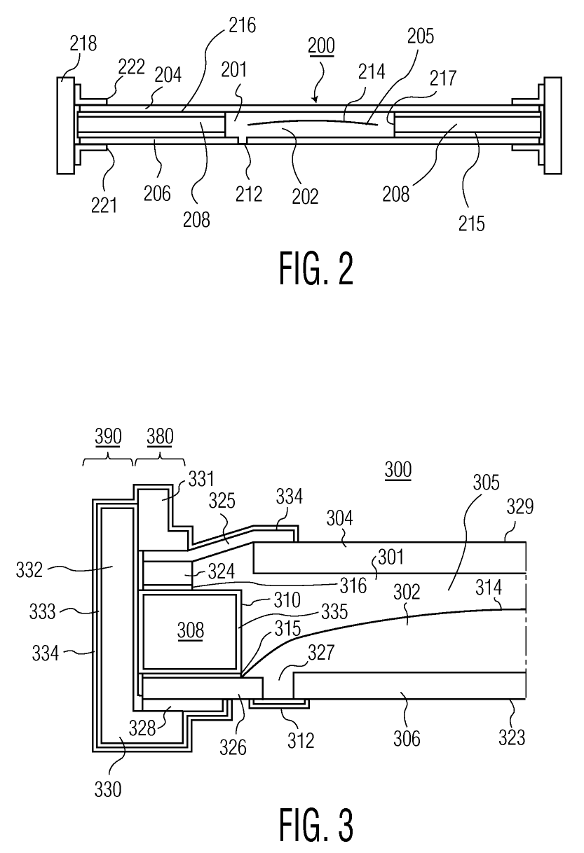

FIG. 2 shows a diagrammatical cross-sectional view of another embodiment of a fluid focus lens of the invention;

FIG. 3 shows a diagrammatical cross-sectional view of a preferred embodiment of the fluid focus lens of the invention; and

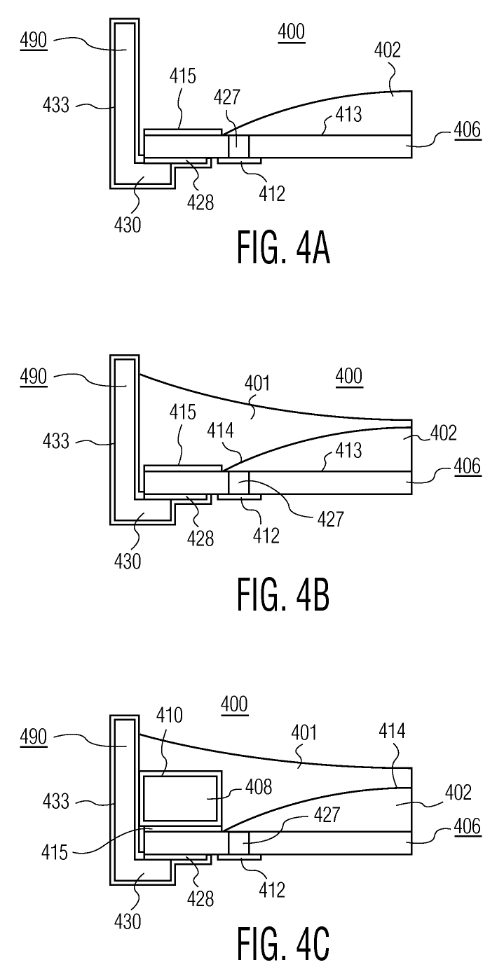

FIGS. 4A, 4B and 4C are views of a portion of the left side of the core of FIG. 3, showing different stages of assembly of a fluid focus lens in accordance with the present invention.

The Figures are diagrammatic and not drawn to scale. The same reference numbers in different Figures refer to like parts.

FIG. 1 shows a fluid or variable focus lens 100 comprising a core 108 forming a cylindrical tube, sealed by substrates in the form of a transparent front element 104 and a transparent back element 106, to enclose a fluid chamber 105 containing two fluids. The core 108 may have a conducting coating applied on the inner wall of the tube.

The two fluids are two non-miscible liquids, an electrically insulating first fluid 101, such as a silicone oil or an alkane, and an electrically conducting second fluid 102, such as water containing a salt solution. The fluids in this embodiment are selected such that the first fluid 101 has a higher refractive index than the second fluid 102.

The core 108 is a first electrode, here in the form of a cylinder of inner radius typically between 1 mm and 20 mm. The core 108 is formed from a metallic material and is coated by an insulating layer 135, formed, for example, of parylene. The core 108 may, however, be non-conducting and have a conducting coating (not shown in FIG. 1) of a conducting material, such as brass or indium tin oxide (ITO), between the core and the insulating layer 135. The core 108 may then be of, for example, polymethylmethacrylate (PMMA), glass or ceramic, provided the material satisfies the requirements of the particular application, e.g., with regard to adhesion of coatings, coefficient of expansion, smoothness of surface, manufacturing costs, etc.

The insulating layer has a thickness of between 50 nm and 10 μm, with typical values between 1 μm and 10 μm. The insulating layer is coated with a fluid contact layer 110, which reduces the hysteresis in the contact angle of the meniscus with the cylindrical wall of the fluid chamber. The fluid contact layer 110 is preferably formed from a hydrophobic material, e.g. an amorphous fluorocarbon such as Teflon™ AF1600 produced by DuPont™. The fluid contact layer 110 has a thickness of between 5 nm and 500 nm.

The parylene coating may be produced by coating the core 108 to form a homogeneous layer of material of substantially uniform thickness. The parylene coating may be applied using chemical vapor deposition. The wettability of the fluid contact layer by the second fluid is substantially equal on both sides of the intersection of the meniscus 114 with the fluid contact layer 110 when no voltage is applied between the first and second electrodes.

A second electrode 112 is arranged at one end of the fluid chamber, in this case, adjacent the back element 106. The second electrode 112 is arranged with at least one part in the fluid chamber such that the electrode acts on the second fluid 102.

The two fluids 101 and 102 are non-miscible so as to tend to separate into two fluid bodies separated by a meniscus 114. When no voltage (VI) is applied between the first and second electrodes, the fluid contact layer has a higher wettability with respect to the first fluid 101 than the second fluid 102. Due to electro-wetting, the wettability by the second fluid 102 varies under the application of a voltage between the first electrode and the second electrode, which tends to change the contact angle of the meniscus at the three phase line (the line of contact between the fluid contact layer 110 and the two fluids 101 and 102). The shape of the meniscus is thus variable in dependence on the applied voltage.

In accordance with the present invention, a first hydrophobic layer 115 is provided on the back element 106 abutting the core 108. The hydrophobic material used may be a fluoride, silicone or a fluorocarbon, such as AF1600 or fluor silane. The hydrophobic material may be applied in the form of a printable coating or applied continuously to the back element 106 with the hydrophobic material subsequently removed by ultraviolet irradiation, UV/ozone treatment or similar process from those parts of the surface of the back element 106 which are not to be made hydrophobic. The first hydrophobic layer 115 has, typically, a thickness of a mono molecular layer, e.g. between 1 nm and 10 μm for fluor silane.

A second hydrophobic layer 116 may be present on the front element 104 in the area facing the core 108.

During assembly of the variable focus lens 100 the first hydrophobic layer 115 holds the fluid 102 in place while the core 108 is placed over the area of the back element 106 on which the first hydrophobic layer 115 is present. The completed variable focus lens 100 is held together by any method or methods, such as clamping or adhesive or application of a sealing material, that will achieve and keep a tight fit, as is known to one of skill in the art.

FIG. 2 is a diagram of a fluid (variable) focus lens 200 in accordance with another embodiment of the invention. Lens 200 includes a first electrically insulating fluid 201 and a second electrically conducting fluid 202, both contained within a fluid chamber 205. The first fluid 201 and the second fluid 202 are non-miscible and in contact with each other over a meniscus 214. The first fluid 201 is in this example a silicone oil, an alkane or another suitable electrically insulating fluid. The second fluid 202 is in this example water containing a salt solution or another suitable electrically conducting fluid.

The fluid chamber 205 is formed by sandwiching an annular core 208 between front and back cover plates 204 and 206. The sidewalls of the chamber 205 are formed by the substantially cylindrical inner wall or surface 217 of annular core 208, while the top and bottom walls are formed by the optically transparent front and back cover plates 204 and 206.

Surrounding the annular core 208 and forming the outer wall of the device is cylindrical wall part 218. Retaining the core/assembly within the outer wall are ring-shaped closing members 221 and 222. Annular core 208, which is insulated from fluid 202, forms a first electrode, while a metal membrane, in contact with fluid 202, forms a second electrode 212 of the fluid focus lens device 200.

In accordance with this embodiment of the invention, a hydrophobic layer 215 is formed on the surface of the back cover plate 206 on all or part of an area that faces the core 208 when the variable focus lens 200 is assembled. A second hydrophobic layer 216 may be present on the front cover plate 204 on areas opposite and in contact with the annular core 208.

Also in accordance with the present invention, a hydrophobic layer may be advantageously placed on the core 208 opposite the hydrophobic layer 215.

The embodiment shown in FIG. 2 allows the lens 200 to be formed as a package that is hermetically sealed and not prone to diffusion of air, water or other fluids. The closing members 221 and 222 are fixedly attached to wall part 218 and hold the cover plates 204 and 206 and core 208 together. Wall part 218 and closing members 221 and 222, may have layers (not shown) of a conductive and ductile material, for example, a metal such as indium or copper, or a conductive composite of a plastic and a metal. To complete the assembly, a sealing layer (not shown) of polymeric coating of rubber, epoxy or similar protective coating or a conductive material such as metal, may overcoat and encapsulate the layers of conductive and ductile material, as well as portions of the cover plates 204 and 206.

FIG. 3 shows an embodiment of a variable focus lens incorporating an electro-wetting cell which also can be completely filled and in which fluid leakage during and after assembly of the cell is avoided. In this FIG. 3 only a partial cross-sectional view is shown, i.e. only the left part of a variable focus lens 300. The variable focus lens 300 is, however, symmetrical, such that the right part, which is not shown, is the mirror of the left part shown here. The lens 300 includes a fluid chamber 305, with an electrically insulating first fluid 301 and an electrically conducting second fluid 302 that are non-miscible and contact each other over a meniscus 314. The sides of the chamber are provided with an electrically insulating layer 335 and a fluid contact layer 310. The fluid contact layer 310 is here also, preferably, hydrophobic.

According to this embodiment, the body section comprises an inner wall 380 and an outer wall 390, and—at a second side 323 of the back cover plate 306—a metallization 328. The inner wall 380 comprises a core 308 that is coated with a fluid contact layer 310. The inner wall 380 also comprises a portion of the end section. This end section (or front cover plate) 304 comprises a ring-shaped glass member 324 that is, through an expandable joint 325, connected to an inner portion. The ring-shaped glass member 324 and the inner portion of the end section 304 may be manufactured from a single glass plate. The inner wall 380 further comprises the end 326 of the back cover plate 306. This back cover plate 306 is provided with a through hole 327, an electrode 312, and the metallization 328. In an alternative embodiment, the plate 306 may be replaced by a construction similar or identical to that at the first side 329 of the variable focus lens 300, i.e. a ring-shaped glass member, an expandable joint and a cover plate.

These three sections of the inner wall 380—the ring-shaped glass member 324, the—also ring-shaped—insulating member 308 and the end 326—are clamped between a protrusion 330 of the outer wall 390 and a ring-shaped closing member 331. The closing member 331 is here a piece of metal, but can be anything with an electrically conducting surface. The outer wall 390 comprises an inner core of plastic or other material 332 that is provided with a metallized surface 333. This metallized surface 333 also covers the metallization 328 of the second cover plate 306. In this manner, a mechanically stable connection is provided.

The inner wall 380 and the outer wall 390 are attached to each other, as well as to the joint 325 and the end section 304, in that a sealing layer 334 is present around it. The sealing layer 334 can be made of any suitable material. For example, a polymeric coating of rubber, epoxy or the like, as are known per se as protective coating may be used. It is, however, preferred that the sealing layer 334 comprises a metal, for example a metal deposited by electroplating. This allows the provision of a package that is hermetical and not prone to diffusion of air, water or fluid.

In this embodiment of the invention, a hydrophobic layer 315 is present on an area of the end 326 of the second cover plate 306 abutting the core 308.

A second hydrophobic layer 316 may be present on the member 324 of the end section 304 that contacts the core 308.

FIG. 4A shows an assembly 400 at one stage of manufacture of a fluid focus lens after an electrically conducting fluid 402 is provided within the outer wall 490 on a second side 413 of a substrate 406. A metal layer 433 extends over the outer wall 490, including a protrusion 430 of the outer wall 490 and is connected to an adhesion layer 428 of the substrate 406. The fluid 402 is in this example an aqueous salt solution. Alcohols and the like may be used as additional solvents. The fluid extends into a hole 427, therewith making contact to an electrode 412. The electrode 412 acts as a closure of the cell. The droplet of electrically conducting fluid 402 is restrained by a first hydrophobic layer 415 on an area of the second side 413 opposite which a core 408 will be placed.

FIG. 4B shows the assembly 400 after the provision of an electrically insulating fluid 401. This is an oil, for instance an alkane or a silicone oil. To prevent contamination of the hydrophilic glass surface with oil, the oil is provided after the electrically conducting fluid 402. The shown shapes of the meniscus 414 and the adhesion to the second side 413 of the substrate 406 are purely diagrammatical and do not necessarily correspond to any physical effect.

FIG. 4C shows the result after the insertion of a core 408. The core 408 is in this case a ring-shaped electrically conducting member 408 that is provided with an electrically insulating layer 410 of parylene. The core 408 is placed on at least a part of the first hydrophobic layer 415, here with a portion of the electrically insulating layer 410, which may also be hydrophobic, opposite a portion of the first hydrophobic layer 415.

The embodiments described above are with regard to a fluid focus lens. The present invention is, however, advantageously used in other devices which include an electro-wetting cell, such as an optical switch, microfluidic pump or microactuator.

The invention is not limited to a single electro-wetting cell on a substrate. A hydrophilic layer in accordance with the present invention may, for example, advantageously be applied to surfaces of a substrate to which two or more or an array of structures containing electro-wetting fluids are fixed.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed devices or portions thereof may be combined together or separated into further portions unless specifically stated otherwise; and

f) no specific sequence of acts is intended to be required unless specifically indicated.

1. An electro-wetting cell comprising a substrate (106, 206, 306, 406), a structure (108, 208, 308, 408) substantially confining an electro-wetting fluid (102, 202, 302, 402) to a surface of the substrate (106, 206, 306, 406) and a first layer of hydrophobic material (115, 215, 315, 415) on the substrate (106, 206, 306, 406) between the substrate (106, 206, 306, 406) and the structure (108, 208, 308, 408).

2. The electro-wetting cell of claim 1 wherein the structure (108, 206) comprises a hollow cylinder.

3. The electro-wetting cell of claim 1 wherein the structure (308, 408) comprises a ring.

4. The electro-wetting cell of claim 1 wherein a hydrophobic fluid contact layer (110, 310, 410) is present on a part of the structure (108, 308, 408).

5. The electro-wetting cell of claim 4, wherein a portion of the hydrophobic fluid contact layer (110, 310, 410) abuts at least a portion of the first layer of hydrophobic material (115, 315, 415).

6. The electro-wetting cell of claim 1 wherein the first layer of hydrophobic material (115, 215, 315, 415) comprises a material which is fluor silane or an amorphous fluorocarbon polymer.

7. A fluid focus lens comprising
a fluid chamber (205) formed by a front cover plate (204), a back cover plate (206) and a core (208) surrounding a space, the fluid chamber (205) including a first fluid (201) and an axially displaced second fluid (202), the fluids (201, 202) being non-miscible, and in contact over a meniscus (214),
a hydrophobic layer (215) disposed on the back cover plate (206) on an area opposite a surface of the core (208).

8. The fluid focus lens of claim 7 wherein the hydrophobic layer (215) is in contact with the second fluid (202) only at an edge of the hydrophobic layer (215).

9. A method of manufacturing an electro-wetting cell comprising:
providing a substrate (406);
providing a hydrophobic layer (415) on a first area of the substrate (406), the first area being shaped to correspond to at least a portion of a contact surface of a structure (108, 208, 308, 408), the structure (108, 208, 308, 408) surrounding a space;
placing an electro-wetting fluid (402) on a second area of the substrate (406); and
placing the structure (108, 208, 308, 408) on the substrate, the contact surface contacting at least a portion of the first area and the space thereby including the second area.

10. The method of claim 9, wherein the placing of the structure (108, 208, 308, 408) on the substrate (406) is after the placing of the electro-wetting fluid (402) on the second area of the substrate (406).

11. The method of claim 9, wherein the placing of the structure (108, 208, 308, 408) on the substrate (406) is before the placing of the electro-wetting fluid (402) on the second area of the substrate (406).

12. The method of claim 9, comprising the step of providing a hydrophilic substrate (406).

13. The method of claim 12, wherein the hydrophilic substrate (406) is glass.

14. The method of claim 9, wherein the step of providing a hydrophobic layer (415) comprises disposing a hydrophobic material on a surface of the substrate (406) and removing the hydrophobic material from a portion of said surface.

15. The method of claim 9, wherein the hydrophobic layer (415) comprises an amorphous fluorocarbon polymer.

16. The method of claim 9, wherein the hydrophobic layer (415) comprises fluor silane.

17. The method of claim 9, wherein the structure (108, 208, 308, 408) has a hydrophobic fluid contact layer (110, 310, 410) and the hydrophobic fluid contact layer (110, 310, 410) is present on at least a portion of the contact surface.

18. A component of an electro-wetting cell, the component comprising a substrate (406) and a layer (415) of hydrophobic material on a portion of the substrate (406), the hydrophobic material being arranged in a pattern corresponding to areas of contact between the substrate (406) and an opposing member (408) of the completed electro-wetting cell.

19. A component as claimed in claim 18, wherein the component is a cover plate of an electro-wetting cell.

20. A component as claimed in claim 18, wherein the component is a part for a fluid focus lens (30).
